(19) United States
(12) Patent Application Publication
(10) Pub. No.: US 2009/0207882 A1
(43) Pub. Date: Aug. 20, 2009

(54) Temperature Sensor Module

(76) Inventor: Tsai-Chung Yu, Taipei Hsien (TW)

Correspondence Address: HDLS Patent & Trademark Services, P.O. BOX 220746, CHANTILLY, VA, 20153-0746, US

(21) Appl. No.: 12/062,743

(22) Filed: Apr. 4, 2008

(30) Foreign Application Priority Data
Feb. 18, 2008 (TW) 097105567

(51) Int. Cl. G01K 7/01

(52) U.S. Cl. 374/178

(57) ABSTRACT

A temperature sensor module includes a first temperature sensor configured for sensing the temperature of the environment, and a second temperature sensor configured for sensing the temperature of an eardrum. The first temperature sensor is a thermal diode, and the second temperature sensor is a thermopile. Preferably, the second temperature sensor may be a CMOS-infrared temperature sensor. The first temperature sensor and the second temperature sensor are both made of the semiconductor material such that they have same physical characters and same raising/falling temperature speeds even if entering into the environment with the different temperatures. Therefore, they are proofread easily, have a low manufacturing cost and consume low power.

### BACKGROUND

1. Field of the Invention

The present invention relates to a temperature sensor adapted in an infrared ear thermometer, and more specifically, to a temperature sensor module having two temperature sensors integrated together.

2. Description of the Related Art

Infrared sensors are mainly divided into two categories: one for thermal sensors, and the other for optical sensors. The thermal sensors are usually adapted in infrared ear thermometers. The thermal sensors mainly include three categories, thermopiles, pyroelectrics, and bolometers. Since any object with a temperature radiates infrared heat radiation, the temperature of environment will be prone to affect greatly the measuring results when using the infrared ear thermometers to measure the temperature of eardrums. Thus the infrared ear thermometers designed and manufactured by manufacturers, need to be auto-compensated based on the temperature of the environment for achieving a substantially accurate measuring result. Generally, a typical infrared ear thermometer includes two temperature sensors. One temperature sensor is configured for sensing the temperature of the eardrum, and the other temperature sensor is configured for sensing the temperature of the environment. The two temperatures sensed by the two temperature sensors, are both processed for achieving a substantially accurate temperature of the eardrum through a compensation operation. The related technology is disclosed in a U.S. Pat. No. 5,024,533, named as “Radiation clinical thermometer”.

Currently, the thermopiles are mainly used as the sensor for sensing the temperature of the eardrum, and the thermistors (one category of the bolometers) are mainly used as the sensor for sensing the temperature of the environment. However, the thermopiles are very different from the thermistors in physical characters and compositions. Especially, when the probe of the infrared ear thermometer enters into the ear canal from the environment with the room temperature, the two temperature sensors have different raising/falling temperature speeds, thus will easily result temperature-measuring errors. Even if the two temperature sensors are both accurately proofread and compensated, the temperature-measuring errors cannot be completely avoided all the same. Furthermore, the thermistors configured for sensing the temperature of the environment, have a high cost, and consume more power; and the thermistors have a poor anti-interfere capability since they calculate the temperature by the measuring-voltage technology

Furthermore, the output voltage of the thermopile relates to the temperature difference between the measured object and the thermopile itself. The temperature of the thermopile must be achieved for accurately achieving the temperature of the measured object. Thus a thermistor needs to be arranged in the thermopile for achieving the temperature of the thermopile by using the relation between the temperature and the resistor value of the thermistor. The related technology is disclosed in a TW Patent No. 00528862, named as “Infrared ear thermometer and corresponding temperature compensating method”. The related technology employs three temperature sensors, which includes an infrared sensor configured for sensing the temperature of the eardrum, a reference temperature sensor configured for the temperature of a substrate of the infrared sensor, and an environment temperature sensor arranged therebetween and configured for sensing the temperature of the environment. However, the reference temperature sensor employed in the above patent, is an independent element, and is packaged with the infrared sensor in a metal can. The reference temperature sensor is also different greatly from the infrared sensor in physical characters. Therefore, they also have different raising/falling temperature speeds when they synchronously enter into the environment with the different temperatures. Thus, the related technology also cannot solve the above problem.

What is needed, is providing a temperature sensor module, which can solve the above problem.

### BRIEF SUMMARY

A temperature sensor module in accordance with an exemplary embodiment of the present invention, includes a first temperature sensor configured for sensing the temperature of the environment, and a second temperature sensor configured for sensing the temperature of an eardrum. The first temperature sensor is a thermal diode, and the second temperature sensor is a thermopile. Preferably, the second temperature sensor may be a CMOS-infrared temperature sensor. The first temperature sensor and the second temperature sensor are both made of semiconductor material such that they have same physical characters. The first temperature sensor and the second temperature sensor have same raising/falling temperature speeds even if entering into the environment with the different temperatures, such that they can be easily proofread to avoid temperature-measuring errors. Furthermore, the thermal diode has a low manufacturing cost compared with the conventional thermistor, and consumes less power; and the thermal diode has an excellent anti-interfere capability since it calculates the temperature by the measuring-current technology.

Preferably, the temperature sensor module may further include a reference temperature sensor configured for sensing the temperature of the second temperature sensor itself to provide a reference temperature. The reference temperature sensor may be also a thermal diode. The reference temperature sensor and the second temperature sensor are integrated on a signal chip by the semiconductor manufacturing technology.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a temperature sensor module, in accordance with a first exemplary embodiment of the present invention;

FIG. 2 is a schematic view of a temperature sensor module, in accordance with a second exemplary embodiment of the present invention; and

FIG. 3 is a schematic view of an infrared ear thermometer, in accordance with a third exemplary embodiment of the present invention.

### DETAILED DESCRIPTION

Reference will now be made to the drawings to describe exemplary embodiments of the present temperature sensor module, in detail. The following description is given by way of example, and not limitation.

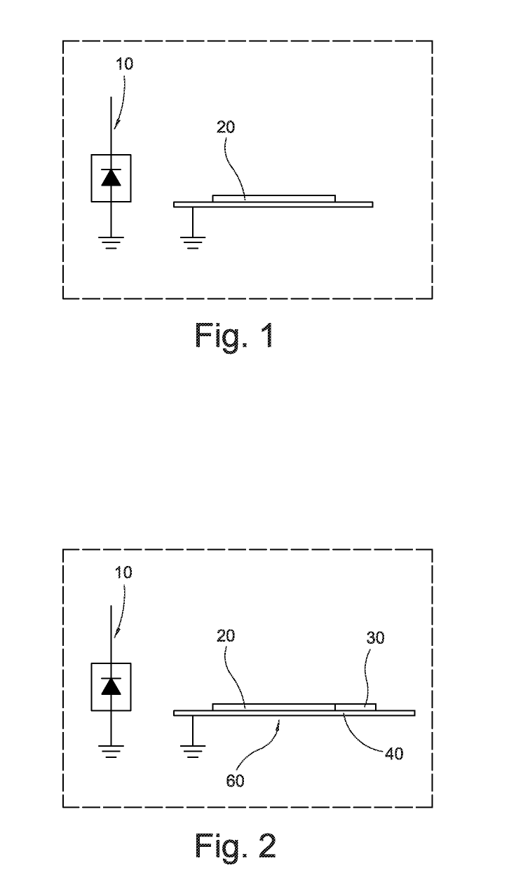

Referring to FIG. 1, a temperature sensor module, in accordance with a first exemplary embodiment of the present shown, is provided. The temperature sensor module, includes:

a first temperature sensor 10 configured for sensing the temperature of the environment, the first temperature being a thermal diode made of semiconductor material and manufactured by the semiconductor manufacturing technology;

a second temperature sensor 20 configured for sensing the temperature of a measured object (such as an eardrum), the second temperature sensor being a thermopile (one category of thermal sensors) or an CMOS-infrared temperature sensor.

The first temperature sensor 10 and the second temperature sensor 20 are both made of the semiconductor material, thus they have same physical characters and same raising/falling temperature speeds when entering into the environment with the different temperatures. Therefore, the present temperature sensor module can avoid temperature-measuring errors.

Referring to FIG. 2, a temperature sensor module, in accordance with a second exemplary embodiment of the present shown, is provided. The temperature sensor module of the present exemplary embodiment is similar to that of the first exemplary embodiment, except further including a reference temperature sensor 30. The reference temperature sensor 30 is configured for sensing the temperature of the second temperature sensor 20 to provide a reference temperature. Especially, if the second temperature sensor 20 is a thermopile, the output voltage thereof will relate to the temperature difference between the measured object and the thermopile itself, and the temperature of the thermopile itself must be achieved for accurately measuring the temperature of the measured object. The reference temperature sensor 30 may be also a thermal diode, and be manufactured by the semiconductor manufacturing technology. Preferably, the second temperature sensor 20 and the reference temperature 30 may be integrated on a substrate 40 by the semiconductor manufacturing technology to form a single-chip temperature sensor module 60.

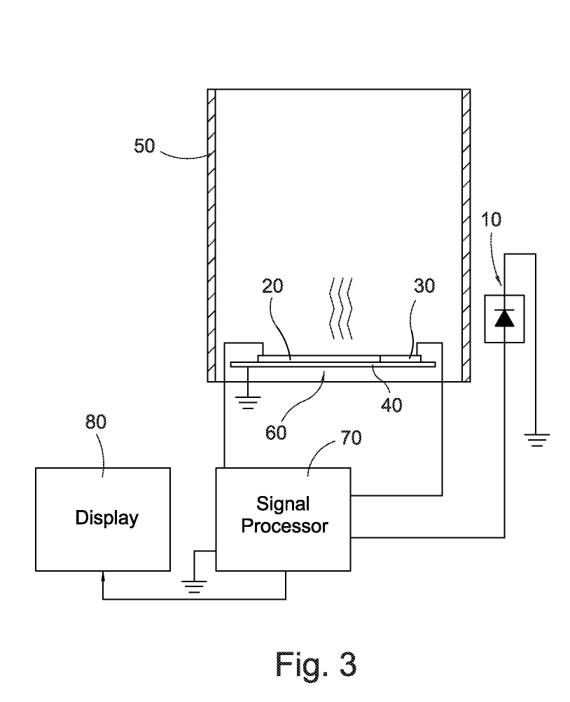

Referring to FIG. 3, an ear thermometer having the temperature sensor module, in accordance with a third exemplary embodiment of the present shown, is provided. The ear thermometer includes:

a wave guide 50 configured for guiding infrared light into an eardrum;

a temperature sensor module 60 having a second temperature sensor 20 and a reference temperature sensor 30 integrated together, the temperature sensor module 60 being configured for sensing the infrared light guided by the wave guide 50 and producing corresponding electrical signals;

a signal processor 70 configured for calculating the accurate temperature of a measured object or the eardrum through a compensation operation based on the temperatures sensed by the second temperature sensor 20 and the reference temperature sensor 30 of the temperature sensor module 60, and the temperature of the environment sensed by a first temperature sensor 10; and

a display 80 (such as a liquid crystal display or a LED display) communicated with the signal processor 70, the display 80 being configured for displaying the accurate temperature of the measured object or the eardrum for users.

The present temperature sensor module employs the thermal diode as the first temperature sensor 10 and employs the thermopile or the CMOS-infrared temperature sensor as the second temperature sensor 20. Thus the first temperature sensor 10 and the second temperature sensor 20 are both made of the semiconductor materials such that they have same physical characters. The first temperature sensor 10 and the second temperature sensor 20 have same raising/falling temperature speeds even if entering into the environment with the different temperatures, such that they can be proofread easily to avoid the temperature-measuring errors. Furthermore, the thermal diode has a low manufacturing cost compared with the thermistor, such that it consumes less power; and the thermal diode has an excellent anti-interfere capability since it calculates the temperature by the measuring-current technology.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A temperature sensor module, comprising:
a first temperature sensor configured for sensing the temperature of the environment;
a second temperature sensor configured for sensing the temperature of a measured object; and
a reference temperature sensor configured for sensing the temperature of the second temperature sensor;
wherein the first temperature sensor is a thermal diode, the second temperature sensor is a thermopile, and the reference temperature sensor is a thermal diode,
wherein the reference temperature sensor and the second temperature sense are integrated on a substrate by the semiconductor manufacturing technology to form a single-chip temperature sensor, but the first temperature sensor is separately formed from the single-chip temperature sensor, and
wherein the first temperature sensor and the second temperature sensor are both made of semiconductor material to have same physical characters of same raising/falling temperature speeds even if entering into the environment with different temperatures, such that the first temperature sensor and the second temperature sensor can be easily proofread to avoid temperature-measuring errors.

2. The temperature sensor module as claimed in claim 1, wherein the second temperature sensor is a CMOS-infrared temperature sensor.

3. (canceled)

4. (canceled)

5. (canceled)

6. The temperature sensor module as claimed in claim 1, wherein the measured object is an eardrum.

7. (canceled)

8. An infrared ear thermometer, comprising:
a wave guide configured for guiding infrared light into a measured object;
a temperature sensor module having a first temperature sensor, a second temperature sensor and a reference temperature sensor, the first temperature sensor being configured for sensing the temperature of the environment, the second temperature sensor being configured for sensing the temperature of the measured object and the reference temperature sensor configured for sensing the temperature of the second temperature sensor, wherein the first temperature sensor is a thermal diode, the second temperature sensor is a thermopile, and the reference temperature sensor is a thermal diode;
a signal processor configured for calculating the accurate temperature of the measured object, based on the temperature of the environment sensed by the first temperature sensor and the temperature of the measured object sensed by the second temperature sensor; and
a display communicated with the signal processor, the display being configured for displaying the accurate temperature of the measured object,
wherein the reference temperature sensor and the second temperature sense are integrated on a substrate by the semiconductor manufacturing technology to form a single-chip temperature sensor, but the first temperature sensor is separately formed from the single-chip temperature sensor, and
wherein the first temperature sensor and the second temperature sensor are both made of semiconductor material to have same physical characters of same raising/falling temperature speeds even if entering into the environment with different temperatures, such that the first temperature sensor and the second temperature sensor can be easily proofread to avoid temperature-measuring errors.

9. The infrared ear thermometer as claimed in claim 8, wherein the second temperature sense is a CMOS-infrared temperature sensor.

10. (canceled)

11. (canceled)

12. (canceled)

13. The infrared ear thermometer as claimed in claim 10, wherein the measured object is an eardrum.
